(19) United States
(12) Patent Application Publication
(10) Pub. No.: US 2026/0102976 A1
(43) Pub. Date: Apr. 16, 2026

(54) ADJUSTMENT METHOD, COATING ELEMENT, AND ADDITIVE MANUFACTURING DEVICE

(71) Applicant: Additive Manufacturing IP GmbH, Munich (DE)

(72) Inventors: Patrick Bregler, Ditzingen (DE); Sören Glock, Erdmannhausen (DE)

(21) Appl. No.: 19/419,144

(22) Filed: Dec. 15, 2025

Related U.S. Application Data
(63) Continuation of application No. PCT/EP2024/064073, filed on May 22, 2024.

(30) Foreign Application Priority Data
Jun. 15, 2023 (DE) 10 2023 115 617.9

(51) Int. Cl. B29C 64/393; B33Y 30/00; B33Y 50/02

(52) U.S. Cl. CPC B29C 64/393; B33Y 30/00; B33Y 50/02

(57) ABSTRACT

An adjustment method for aligning components of an additive manufacturing device using a coating element of the additive manufacturing device, the coating element having a measuring device, the method including positioning at least one measuring probe of the measuring device in an alignment position vertically above a process plate of the additive manufacturing device. The measuring probe has a reference position with a vertical reference distance to a manufacturing plane of the additive manufacturing device. The method further includes aligning the manufacturing plane and the process plate relative to each other by adjusting at least one height adjustment of the additive manufacturing device. The adjusting is performed until the process plate contacts the measuring probe in the reference position.

### CROSS REFERENCE TO RELATED APPLICATIONS

This application is a continuation of International Application No. PCT/EP2024/064073 (WO 2024/256137 A1), filed on May 22, 2024, and claims benefit to German Patent Application No. DE 10 2023 115 617.9, filed on Jun. 15, 2023. The aforementioned applications are hereby incorporated by reference herein.

### FIELD

The invention relates to an adjustment method for aligning components of an additive manufacturing device, to a coating element, and an additive manufacturing device.

### BACKGROUND

Such methods and devices are typically used before the additive manufacturing device is put into operation and before individual manufacturing orders are produced by the additive manufacturing device.

In this process, the various components of the additive manufacturing device are coordinated with each other in terms of their coordinate system and alignments in order to enable interaction within a predetermined coordinate system of the additive manufacturing device.

Inadequate coordination leads to a significant reduction in the manufacturing quality of the additive manufacturing device.

For example, the alignment of a process chamber or a process chamber base flush with a building platform is crucial for the formation of a layer thickness of the process powder to be solidified. Furthermore, for example, a coating element must be positioned in a manufacturing plane of the additive manufacturing device to ensure effective introduction of the process powder.

In addition, with conventional additive manufacturing devices, the substrate plate must be moved to a predetermined manufacturing plane or to a coating and exposure plane before each production order is executed. This can lead to misalignment and/or tilting of the substrate plate relative to the manufacturing plane, for example due to wear or thermal expansion of the substrate plate and/or inaccuracies in the height adjustment, which also has a negative effect on the manufacturing quality.

Alignment prior to commissioning of the additive manufacturing device is typically performed by an operator by means of time-consuming and laborious manual adjustment of the individual components. The operator also ensures the proper alignment of the substrate plate manually.

Although the manufacturing quality of the additive manufacturing device can be maintained at a high level using the known methods, this is only possible at a reduced manufacturing speed and with a reduced degree of automation of the additive manufacturing speed.

### SUMMARY

In an embodiment, the present disclosure provides an adjustment method for aligning components of an additive manufacturing device using a coating element of the additive manufacturing device, the coating element having a measuring device, the method comprising positioning at least one measuring probe of the measuring device in an alignment position vertically above a process plate of the additive manufacturing device. The measuring probe has a reference position with a vertical reference distance to a manufacturing plane of the additive manufacturing device. The method further comprises aligning the manufacturing plane and the process plate relative to each other by adjusting at least one height adjustment of the additive manufacturing device. The adjusting is performed until the process plate contacts the measuring probe in the reference position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an embodiment of an adjustment method in a schematic representation;

FIG. 2 illustrates an embodiment of the adjustment method in a schematic representation;

FIG. 3 illustrates an additive manufacturing device with a coating element having a measuring device in a perspective view;

FIG. 4 illustrates the additive manufacturing device from FIG. 3 with the coating element positioned above a manufacturing cylinder in a perspective view;

FIG. 5 illustrates a first detail of the additive manufacturing device from FIG. 4 in a side view;

FIG. 6 illustrates a second detail of the additive manufacturing device with the coating element positioned above a reference segment in a side view;

FIG. 7 illustrates a third detail of the additive manufacturing device with a measuring probe positioned at the reference segment;

FIG. 8 illustrates an embodiment of the measuring device with two measuring probes in a sectional side view;

FIG. 9 illustrates an open pneumatic valve of a measuring probe of the measuring device from FIG. 8 in a detailed view;

FIG. 10 illustrates the measuring device from FIG. 8 in a deflected state of the measuring probes;

FIG. 11 illustrates a closed pneumatic valve of a measuring probe of the measuring device from FIG. 10 in a detailed view;

FIG. 12 illustrates a detailed view of an open pneumatic valve of a measuring probe of the measuring device from FIG. 10;

FIG. 13 illustrates a closed pneumatic valve in a schematic representation;

FIG. 14 illustrates an open pneumatic valve in a schematic representation; and

FIG. 15 illustrates a closed pneumatic valve in a schematic representation.

### DETAILED DESCRIPTION

In an embodiment, the present disclosure provides a method and a device in which the production speed and the degree of automation can be improved while maintaining high production accuracy.

According to an embodiment of the present disclosure, an adjustment method is provided.

The adjustment method is designed to align components of an additive manufacturing device. To carry out the method, a coating element of the additive manufacturing device comprising a measuring device is used. In other words, the coating element provided in the additive manufacturing device for manufacturing production orders is used to align the components with each other.

For this purpose, the coating element has a measuring device with at least one measuring probe. The measuring device can be arranged and/or designed on the coating element, in particular in a detachable manner.

The adjustment method is designed at least for aligning at least two components of the additive manufacturing device with each other. Preferably, the adjustment method is designed for aligning several components, in particular all components, of the additive manufacturing device with each other.

Alignment is previously and subsequently understood to mean the arrangement of components in a predetermined position i.e., a predetermined position and alignment relative to each other. Preferably, the components are aligned relative to each other in a uniform coordinate system of the additive manufacturing device.

Components of the additive manufacturing device can include, for example, but are by no means limited to, the coating element, the measuring device, a process chamber base, a process plate, and/or a processing unit, in particular a laser processing unit.

A process plate can be understood, for example, as a building platform for producing a production order of the additive manufacturing device and/or a calibration plate for calibrating the processing unit, in particular the laser processing unit. The calibration plate is typically an optical calibration plate and is designed for arrangement in a manufacturing plane of the additive manufacturing device.

The adjustment method comprises at least the following method steps:

Method step d) provides for the positioning of at least one measuring probe of the measuring device described above and below in an alignment position vertically above the process plate of the additive manufacturing device.

Typically, the measuring device is positioned above the process plate of the additive manufacturing device by moving the coating element by means of a linear guiding. Typically, the linear guiding for moving the coating element is designed to move along or parallel to a second main extension direction of the manufacturing plane. In other words, the linear guiding is designed to move a working axis of the coating element parallel to the second main extension direction.

The alignment position can be understood as a position perpendicular to the manufacturing plane, preferably vertical, in a reference position with predetermined coordinates along a first main extension direction and the second main extension direction of the manufacturing plane. The reference position is typically parallel to the manufacturing plane.

The measuring probe has the reference position with a predetermined perpendicular reference distance to the manufacturing plane of the additive manufacturing device. In other words, method step d) provides for the use of a measuring probe aligned with the manufacturing plane.

A further method step f) provides for the alignment of the manufacturing plane and the process plate with each other by adjusting at least one height adjustment of the additive manufacturing device. The height adjustment is adjusted until the process plate touches the measuring probe in the reference position.

The additive manufacturing device typically has several height adjustments. A height adjustment device can be designed to adjust a vertical position of the process chamber, in particular the process chamber base, and/or a vertical position of a process plate. For example, it can be provided that the process chamber has at least one telescopic support leg. Furthermore, for example, it can be provided that a manufacturing cylinder of the additive manufacturing device has a height adjustment in the form of a lifting device for the process plate.

The height adjustments are preferably motor-adjustable. This allows adjustment to be carried out by the additive manufacturing device.

According to the present disclosure, the process plate can thus be moved toward the measuring probe and/or the manufacturing plane with the coating element having the measuring probe can be moved toward the process plate. The adjustment continues until the process plate is touched by the measuring probe. In other words, contact between the measuring probe and the process plate is determined. When contact is made between the measuring probe and the process plate, the process plate and the manufacturing plane are at the alignment point or the process plate has a known distance from the manufacturing plane.

Preferably, the manufacturing position of the additive manufacturing device is horizontal or aligned horizontally. Furthermore, preferably, the process plate is arranged horizontally in the additive manufacturing device. This allows for particularly precise alignment of the manufacturing plane with the process plate.

In summary, the problem underlying the present disclosure is solved by the fact that the components can be aligned by the additive manufacturing device using a measuring device arranged on the coating element of the additive manufacturing device. The measuring device or measuring probe is aligned with a manufacturing plane of the additive manufacturing device so that the process plate can be easily aligned with the manufacturing plane and/or the manufacturing plane can be easily aligned with the process plate by moving the measuring probe over the process plate and performing a height adjustment until the measuring probe touches the process plate.

The method according to the present disclosure is thus independent of operator intervention and therefore enables the manufacturing job to be started automatically. This increases the effectiveness and automation of the additive manufacturing device.

In addition, the components can be aligned independently of the installation of the additive manufacturing device, as the components can be adapted to the given position of the additive manufacturing device.

In an embodiment, the adjustment method comprises method step a), which provides for determining a reference segment of the additive manufacturing device. In other words, a section of the additive manufacturing device is determined to which the components of the additive manufacturing device are aligned. The reference segment is typically formed parallel to the first main extension direction of the manufacturing plane of the additive manufacturing device.

In addition, the adjustment method in this embodiment comprises the method step b), which provides for aligning the coating element with the reference segment of the manufacturing plane. Typically, the coating element is formed parallel to the first main extension direction, so that alignment of the coating element with the reference segment can be carried out particularly easily.

Alignment of the coating element can be carried out in particular by lowering the coating element onto the reference segment. In other words, the vertical position of the coating element is changed until tactile contact is made between the coating element and the reference segment. The alignment can be performed by a lowering device of the coating element. By lowering the coating element, a particularly quick and easy parallel alignment of the coating element to the reference segment can be achieved.

The reference segment can be formed in the manufacturing plane of the additive manufacturing device. In addition, the reference segment can be formed at a predetermined distance from the manufacturing plane. In other words, the reference segment can have a reference segment height. This protects the reference segment from process-related contamination and thus enables alignment of the coating element during operation of the additive manufacturing device.

If the reference segment has a reference segment height relative to the manufacturing plane, the reference segment height is taken into account when aligning the components with each other. For example, the components can be corrected by the reference segment height after being probed by the measuring probe. Furthermore, it can be provided, for example, that the measuring probe protrudes beyond the coating element by the reference segment height. This eliminates the need for correction by the reference segment height.

The reference segment can be designed as a continuous section or as several sub-sections. The sub-sections are preferably identical in terms of their dimensions and design, but are spaced apart from each other along or parallel to the first main extension direction.

It is particularly preferred that the reference segment is designed horizontally. This allows the components of the additive manufacturing device to be easily aligned horizontally.

In an embodiment, the adjustment method also includes method step c), which provides for determining the reference distance of the measuring probe to the manufacturing plane by probing the reference segment at least once with the measuring probe. In other words, the method step provides for aligning the measuring probe to the manufacturing plane. This allows a reference distance of the measuring probe to be set and/or checked. For example, the aligned coating element can be moved along the second main extension direction so that the measuring probe is positioned above the reference segment. The measuring probe, or a measuring pin of the measuring probe, is deflected by the reference segment height in the correctly aligned state. If the deflection of the measuring probe does not correspond to the reference segment height, the measuring probe can be readjusted.

In an embodiment, the adjustment method comprises step e), wherein the measuring pin of the at least one measuring probe is deflected in the vertical direction up to the process plate. In other words, the measuring pin is extended in the direction of the process plate until contact is made between the measuring pin and the process plate. The deflection of the measuring pin can be determined as a process plate distance between the process plate and the reference position. Typically, the embodiment in method step f) comprises adjusting the at least one height adjustment by the previously determined process plate distance. In other words, the measuring pin, in the state adjacent to the process plate, is moved into the alignment position or the reference position of the measuring probe by adjusting the process plate and/or the production plate.

In an embodiment of the adjustment method, the method steps d) to f) are performed for at least one further alignment position. The at least one further alignment position is formed vertically above the process plate. The at least one further alignment position is spatially spaced from the at least one alignment position in a plane parallel to the manufacturing plane. In other words, the process plate and the manufacturing plane are aligned with each other at at least two points on the process plate. By using more than one alignment position, an inclination between the process plate and the manufacturing plane can be determined and corrected.

In addition, a further development of the adjustment method is preferred, in which alignment is performed at at least one first alignment position and at least one second alignment position. The first alignment position and the second alignment position are arranged parallel to the first main extension direction of the manufacturing plane. In other words, the alignment positions are formed perpendicular to a coating movement. This facilitates alignment of the components around the second main extension direction.

In an embodiment of the adjustment method, the measuring device has at least two measuring probes. The adjustment of the at least one height adjustment is typically carried out until the at least two measuring probes in the respective reference position are touched in pairs by the process plate. This allows the components to be aligned with each other even more quickly.

An embodiment of the adjustment method is also preferred, in which method steps d) to f) are carried out for at least one further first alignment position and at least one further second alignment position. The at least one further first alignment position and the at least one further second alignment position are arranged at a distance from the at least one first alignment position and the at least one second alignment position along a second main extension direction. Preferably, the further first alignment position and the further second alignment position are offset parallel to the one first alignment position and the one second alignment position in the second main extension direction. In other words, in addition to alignment parallel to the first main extension direction, the process plate can be scanned in the second main extension direction.

Preferably, method steps d) to f) are performed for a plurality of pairs of first and second alignment positions along the second main extension direction. It is particularly preferred that the process plate and the manufacturing plane are aligned with each other during continuous movement of the coating element having the measuring device along the second main extension direction. This allows particularly accurate and at the same time rapid alignment of the components.

The adjustment method can provide that the aligned process plate is then used to align further components of the additive manufacturing device. For example, it can be provided that the process plate is designed as an optical calibration plate and that the laser processing optics are calibrated using the calibration plate aligned with the manufacturing plane.

The underlying task is further solved by a coating element for an additive manufacturing device.

The coating element is specifically designed to perform the adjustment method described above and below.

The coating element typically has a coating lip. The coating lip is designed to remove process powder during the production of a manufacturing order in the additive manufacturing device. When positioned in the additive manufacturing device, the coating lip is preferably in sliding contact with the manufacturing plane or with the process chamber base.

The coating element also has a measuring device with at least one measuring probe. The measuring probe protrudes vertically beyond the coating lip. The measuring probe is designed for tactile sensing through the process plate.

In an embodiment of the coating element, the measuring probe has a probing mechanism and a measuring pin. The measuring pin is typically displaceable relative to the probing mechanism in order to detect sensing through the process plate. Detection by the probing mechanism can be effected, for example, by deflecting the measuring pin in a deflection scale. Furthermore, it can be provided that detection of the probing is effected by triggering an electronic, mechanical, and/or pneumatic switching operation.

In addition, an embodiment of the coating element is preferred, in which the measuring probe is designed to be arranged in a reference position by fixing a measuring pin location of the measuring pin relative to the probing mechanism. In other words, an undeflected state of the measuring probe can be determined, from which a deflection of the measuring pin is to be detected. This allows the measuring probe to be adjusted to different reference distances.

An embodiment of the coating element is one in which the measuring probe is designed to extend in a vertical direction. Preferably, the measuring probe is designed to be extendable incrementally or in steps. This allows the measuring probe to be moved toward a component to be aligned for probing, thereby increasing the flexibility of the coating element in aligning the components.

In an embodiment of the coater, the probing mechanism has a pneumatic valve. The measuring pin is preferably designed to switch the pneumatic valve. The deflection of the measuring pin can thus be detected by means of a pneumatic pressure system provided on the coating element, which keeps the costs for the provision and operation of the coating element low.

An embodiment of the coating element is one in which the measuring device has at least two measuring probes. The measuring probes are arranged perpendicular to a working axis of the coating element. Typically, the working axis of the coating element is parallel to the second main extension direction of the manufacturing plane. The measuring probes are preferably arranged at a distance from each other in an extension direction of the coating element, wherein the extension direction runs parallel to the first main extension direction of the manufacturing plane when the coating element is arranged in the additive manufacturing device.

In an embodiment of the coater, the measuring device is detachably arranged on the coater. In other words, the measuring device can be detached from the coater, in particular by means of the additive manufacturing device. For this purpose, the measuring device preferably has a coater coupling. The detached measuring device can be positioned by the coating element in a tool magazine of the additive manufacturing device and removed for aligning the components. This allows the dimensions of the coating element to be kept compact and the weight low.

The underlying problem is further solved by an additive manufacturing device.

The additive manufacturing device is typically designed for additive manufacturing of production orders in a process chamber. The additive manufacturing device comprises a manufacturing cylinder with a process plate and a coater described above and below.

The coating element is designed to move the measuring device along the second main extension direction of the manufacturing plane of the additive manufacturing device above the process plate.

Further features and advantages of the present disclosure are apparent from the description and the drawings. According to the present disclosure, the aforementioned features and those described in further detail can be used individually or in any suitable combination. The embodiments shown and described are not to be understood as an exhaustive list, but rather are intended to serve as examples.

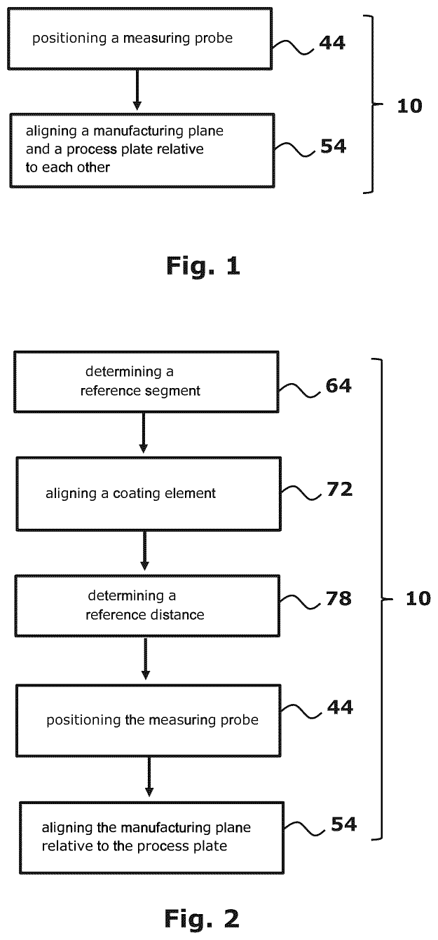

FIG. 1 shows an adjustment method 10 according to the present disclosure for aligning components of an additive manufacturing device 12.

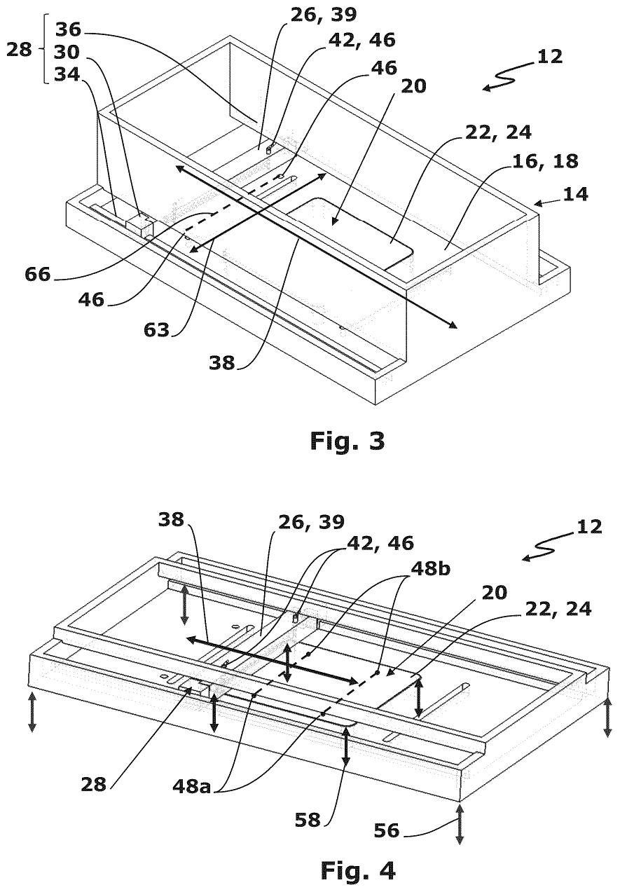

Such an additive manufacturing device 12 is shown schematically in FIG. 3, for example. The additive manufacturing device 12 typically has a process chamber 14 with a process chamber base 16. The process chamber base 16 is typically formed on a side facing the inside of the process chamber 14 as a manufacturing plane 18 of the additive manufacturing device 12. In other words, the process chamber base 16 forms a plane with respect to which a manufacturing job is additively manufactured in the process chamber 14.

Common additive manufacturing devices 12 have a manufacturing cylinder 20 for additive manufacturing with at least one process plate 22 movably and detachably arranged therein, for example a building platform 24 for manufacturing a manufacturing job. The process plate 22 is typically designed to be movable within the manufacturing cylinder 20 perpendicular to the manufacturing plane 18. During additive manufacturing, the building platform 24 is typically lowered step by step relative to the manufacturing plane 18, creating a process powder trough for receiving process powder. Typically, the process powder trough thus created is then filled with process powder and solidified in areas under the action of a laser beam. The building platform 24 is then lowered again and another layer of process powder is applied and solidified. The manufacturing steps described are repeated until the manufacturing job is complete.

The additive manufacturing device 12 has a coating element 26 for filling the process powder trough with process powder. The coating element 26 is typically arranged to be movable in the process chamber 14 by means of a linear guiding 28. As shown, the linear guiding 28 can have a carriage 30 on which the coating element 26 is arranged.

The carriage 30 extends in a first main extension direction 32 of the manufacturing plane 18 from a first guide rail 34 to a second guide rail 36 of the linear guiding 28. The guide rails 34, 36 typically extend parallel to each other in a second main extension direction 38 of the manufacturing plane 18. The carriage 30 is movably arranged on the guide rails 34, 36 and is thus designed to be movable along the second main extension direction 38 of the manufacturing plane 18 together with the coating element 26. In other words, the coating element 26 can be moved within the process chamber 14, or above the manufacturing cylinder 20 and the process plate 22.

Preferably, the guide rails 34 are designed to be both parallel to each other and parallel to the manufacturing plane 18 or the process chamber base 16. A method step in the adjustment method 10 can provide for the guide rails 34 to be aligned parallel to each other and parallel to the process chamber base 16. This can increase the accuracy of the adjustment method 10.

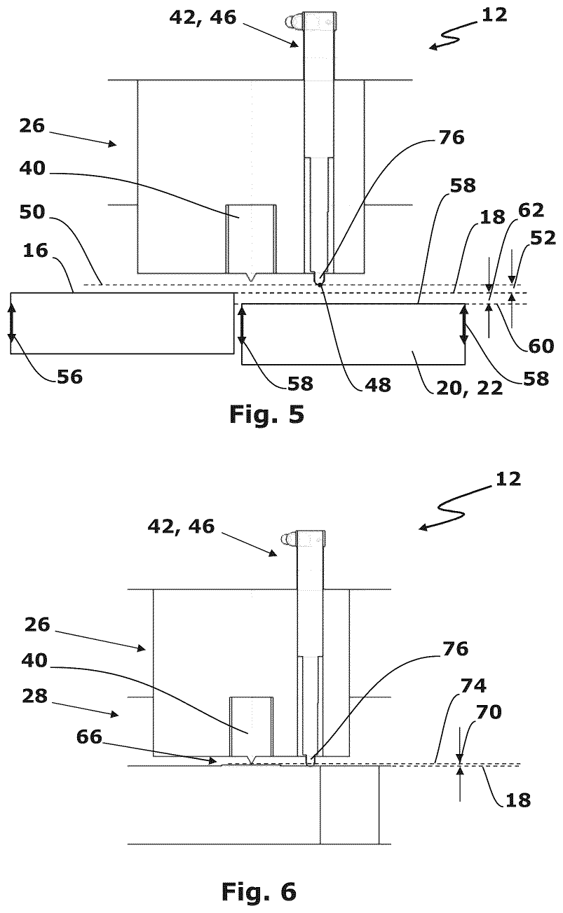

During filling of the process powder trough, the coating element 26 is moved along the second main extension direction 38 of the manufacturing plane 18 with a coating tool 39 arranged thereon, wherein process powder is discharged from the coating tool 39 into the process powder trough and is detracted flush with the manufacturing plane 18, for example, by means of a coating lip 40 (see FIG. 5) of the coating tool 39.

The coating tool 39 can be detachably arranged or attached to the coating element 26. Typically, the coating element 26 is designed for the arrangement of different coating tools 39. The coating tools 39 can, for example, be stored in a tool magazine of the additive manufacturing device 12 and, if necessary, be removed by the coating element 26, in particular automatically.

According to the present disclosure, the adjustment method 10 is carried out using the coating element 26 of the additive manufacturing device 12. In other words, existing components can be advantageously used to align the components of the additive manufacturing device 12.

The coating element 26 has a measuring device 42 (see FIGS. 3-12). The measuring device 42 can be formed on the coating element 26. Preferably, the measuring device 42 is detachably arranged on the coating element 26. It is particularly advantageous if the measuring device 42 can be removed from the tool magazine of the additive manufacturing device 12 by the coating element 26, especially before the start of a manufacturing job by the additive manufacturing device 12. The removal of the measuring device 42 can be automated, thereby further increasing the degree of automation of the additive manufacturing device 12.

According to a process step 44 of the adjustment method 10 according to the present disclosure, at least one measuring probe 46 of the measuring device 42 is provided in an alignment position 48 (see FIG. 5) vertically above the process plate 22 of the additive manufacturing device 12. The measuring probe 46 is located in a reference position 50 with a predetermined vertical reference distance 52 from the manufacturing plane 18 of the additive manufacturing device 12.

The reference position 50 of the measuring probe 46 can lie in the manufacturing plane 18. In other words, the reference distance 52 can be zero. The reference distance 52 is typically predetermined or set and/or adjusted to a specific value. The reference distance 52 is taken into account when aligning the components of the additive manufacturing device 12.

A further method step 54 provides for the alignment of the manufacturing plane 18 and the process plate 22 with respect to each other. According to the present disclosure, alignment can be achieved by adjusting at least one height adjustment 56, 58 (see FIGS. 4, 5) of the additive manufacturing device 12. The adjustment is carried out until the measuring probe 46 is touched or contacted by the process plate 22 in the reference position 50.

The additive manufacturing device 12 typically has several height adjustments 56, 58. As shown in FIG. 4, the additive manufacturing device 12 can have at least four height adjustments 56 for adjusting the height of the process chamber 14 or the process chamber base 16. In addition, the additive manufacturing device 12 can have four height adjustments 58 for adjusting the height of the manufacturing cylinder 20. The height adjustments 56, 58 can be designed to be adjustable in both directions. The height adjustments 56, 58 can be designed to be adjustable individually or jointly. For clarity, only one height adjustment 56 and one height adjustment 58 are marked with a reference symbol in FIG. 4.

Alignment of the manufacturing plane 18 and the process plate 22, as shown in FIG. 5, can thus be achieved by lowering the height adjustment 56 of the process chamber base 16 and/or by raising the height adjustment 58 of the manufacturing cylinder 20, together with the process plate 22.

The process plate 22 is raised in accordance with FIG. 5 starting from an undefined process plate position 60, which has an undefined process plate distance 62 from the manufacturing plane 18, until the process plate 22 contacts or touches the measuring probe 46. The process plate 22 is then in the reference position 50 of the measuring probe 46, which is aligned with the coating element 26 and the process chamber base 16.

In particular, in the case where a reference position 50 has a reference distance 52 to the manufacturing plane 18, a method step of the adjustment method 10 can provide that the process plate 22 is subsequently lowered by the reference distance 52 following method step 54.

Preferably, method steps 44, 54 are performed for at least one further alignment position 48, which is arranged in the reference position 50 at a distance from the at least one alignment position 48. This allows an inclination between the process plate 22 and the manufacturing plane 18 or the process chamber base 16 to be compensated.

The at least one further alignment position 48 can, for example, be spaced apart from the at least one alignment position 48 along the second main extension direction 38. By probing the process plate 22 at at least two alignment positions 48 along the second main extension direction 38, a rotation of the process plate 22 about the first main extension direction 32 relative to the manufacturing plane 18 can be corrected.

The at least one further alignment position 48 can further be spaced apart from the at least one alignment position 48, for example, along the first main extension direction 32. By probing the process plate 22 at at least two alignment positions 48 along the first main extension direction 32, a rotation of the process plate 22 about the second main extension direction 38 relative to the manufacturing plane 18 can be corrected.

A correction can relate both to the alignment of the process chamber 14 or the process chamber base 16 relative to the process plate 22 and to the alignment of the process plate 22 relative to the process chamber base 16.

Furthermore, the method steps 44, 54 are preferably carried out for at least a first alignment position 48a (see FIG. 4) and at least a second alignment position 48b (see FIG. 4) by adjusting the at least one height adjustment 56, 58 once. In other words, the components of the additive manufacturing device 12 are aligned at two alignment positions 48, 48a, 48b simultaneously. In this case, the measuring device 42 preferably has at least two measuring probes 46. Typically, the at least one first alignment position 48a and the at least one second alignment position 48b are arranged or designed parallel to the first main extension direction 32 of the manufacturing plane 18.

The method steps 44, 54 are particularly preferably carried out for further first alignment positions 48a and further second alignment positions 48b. For this purpose, the coating element 26 can be moved along the second main extension direction 38 above the process plate 22.

FIG. 2 shows a further embodiment of the adjustment method 10. The embodiment of the adjustment method 10 according to FIG. 2 differs from the embodiment of the adjustment method 10 according to FIG. 1 in that it includes upstream method steps, which are explained below with reference to the remaining figures of the drawing.

At an upstream method step 64, a reference segment 66 (see FIG. 3) of the additive manufacturing device 12 is determined. The reference segment 66 is typically formed parallel to the first main extension direction 32 of the manufacturing plane 18.

The reference segment 66 can lie in the manufacturing plane 18. Preferably, the reference segment 66 has a reference segment height 70 perpendicular to the manufacturing plane 18. By raising the reference segment 66 relative to the manufacturing plane 18, the reference segment 66 can be kept insensitive to process powder located in the process chamber 14. This can improve the robustness of the adjustment method 10.

A further method step 72 provides for the alignment of the coating element 26 with the reference segment 66 of the additive manufacturing device 12. In other words, the coating element 26 is moved to a known position relative to the manufacturing plane 18.

The coating element 26 can be aligned, as shown in FIG. 6, by lowering the coating element 26 onto the reference segment 66.

The coating element 26 can be lowered, for example, by loosening a coating element fixation on the carriage 30 (see FIG. 3) of the linear guiding 28 and moving the coating element 26 in the vertical direction. Preferably, the coating element 26 is lowered in the vertical direction until the coating lip 40 contacts or touches the reference segment 66. The coating element 26 can then be in a coating element location 74 that is offset from the manufacturing plane 18 by the reference segment height 70.

Preferably, the measuring probe 46 or a measuring pin 76 of the measuring probe 46 protrudes vertically beyond the coating lip 40. It is particularly preferred that the measuring probe 46 protrudes vertically beyond the coating lip 40 by the reference segment height 70. This allows the process plate 22 (see FIGS. 3-5) to be aligned without subsequent correction.

A further method step 78 can provide for determining the reference distance 52 of the measuring probe 46 to the manufacturing plane 18 by probing the reference segment 66 at least once with the measuring probe 46. In other words, a reference distance 52 can be checked, corrected, and/or redetermined. The reference distance 52 is preferably determined automatically by the additive manufacturing device 12, so that the degree of automation of the additive manufacturing device 12 can be increased and the robustness of the adjustment method 10 can be further enhanced.

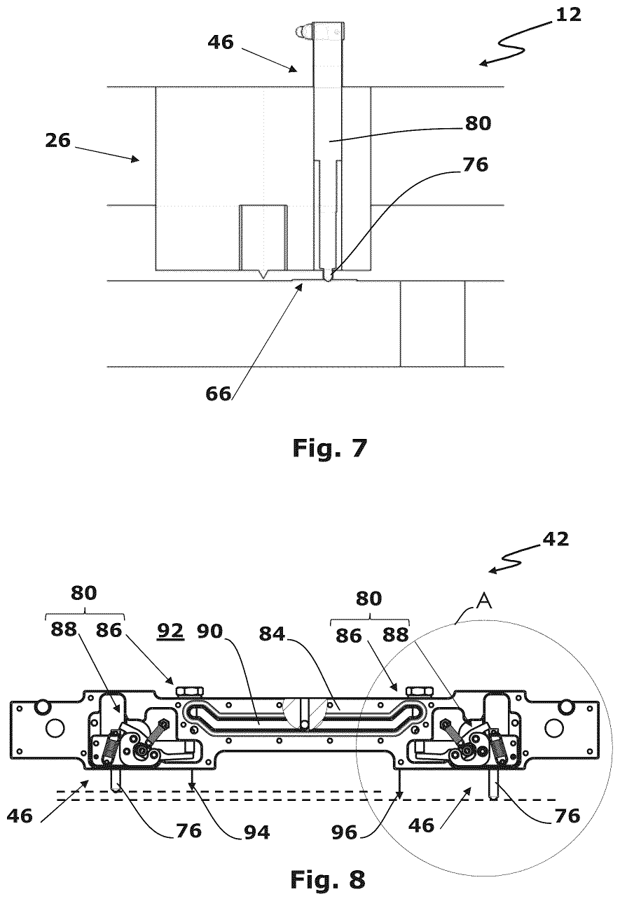

The reference distance 52 can be determined as shown in FIG. 7. As shown, the coating element 26 can be moved together with the measuring probe 46 to a position above the reference segment 66. By probing the reference segment 66, the measuring pin 76 of the measuring probe 46 is deflected in the vertical direction. The deflection can then be determined by a probing mechanism 80, for example a deflection scale, of the measuring probe 46. Subsequently, the measuring probe 46 can be adjusted relative to the coating element 26 if necessary. In other words, a measuring pin location 82 of the measuring pin 76 can be determined relative to the probing mechanism 80.

FIG. 8 shows an embodiment of a measuring device 42.

The measuring device 42 has two measuring probes 46. The measuring probes 46 each comprise a measuring pin 76 and a probing mechanism 80. The measuring probes 46 are arranged on a common base body 84 of the measuring device 42.

The probing mechanisms 80 each have a pneumatic valve 86 and a probe gear 88. The probe gear 88 extends from the respective pneumatic valve 86 of the measuring probe 46 to the measuring pin 76. The pneumatic valves 86 of the measuring probes 46 seal an internal volume 90 of the base body 84, which is at overpressure, from an environment 92 of the measuring device 42.

By actuating one of the measuring probes 46 or by deflecting one of the measuring pins 76 in the vertical direction, the deflection movement of the measuring pin 76 is transmitted via the probe gear 88 to the pneumatic valve 86 of the respective measuring probe 46. This opens the pneumatic valve 86 and causes a pressure drop in the internal volume 90. The pressure drop can be measured by a control system of the additive manufacturing device 12 and a probing of the measuring probe 46 can be detected.

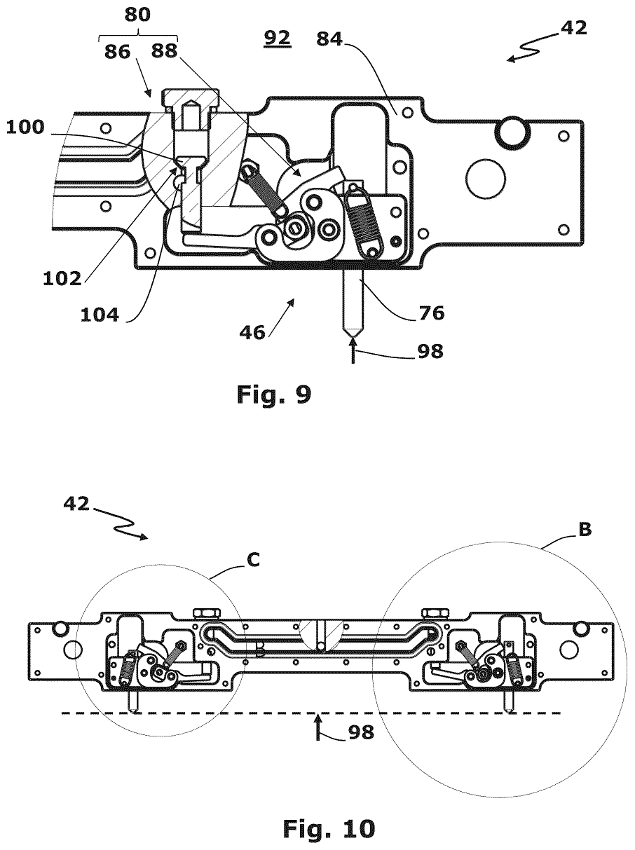

The measuring pins 76 have different measuring pin deflections 94, 96 relative to the base body 84 or the respective probing mechanism 80. By means of a different measuring pin deflection 94, 96, individual probing of the respective measuring probes 46 can be performed on a common internal volume 90, which is explained with reference to the following FIGS. 9 to 12.

FIG. 9 shows a detailed view A of the measuring device 42 from FIG. 8.

If the measuring pin 76 is deflected in the direction of the arrow direction 98, for example upon contact with the process plate 22 (see FIGS. 3-5) or the reference segment 66, the measuring pin 76 deflects the probe gear 88 so that a valve head 100 of the pneumatic valve 86 is lifted out of a valve seat 102 of the base body 84 and a flow path 104 into the environment 92 of the measuring device 42 is opened.

The state of the pneumatic valve 86 is shown schematically in FIG. 14 for clarification.

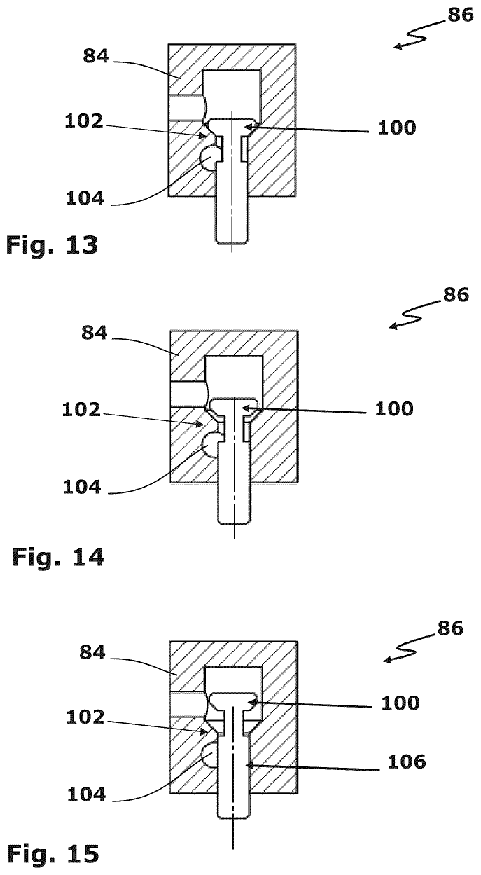

The other measuring probe 46 (see FIG. 8) is not contacted, so that the pneumatic valve 86 of the measuring probe 46 remains closed. The state of the other measuring probe 46 is shown schematically in FIG. 13 for clarification.

FIG. 10 shows the measuring device 42 from FIG. 8 with increasing deflection of the measuring pins 76 in the arrow direction 98.

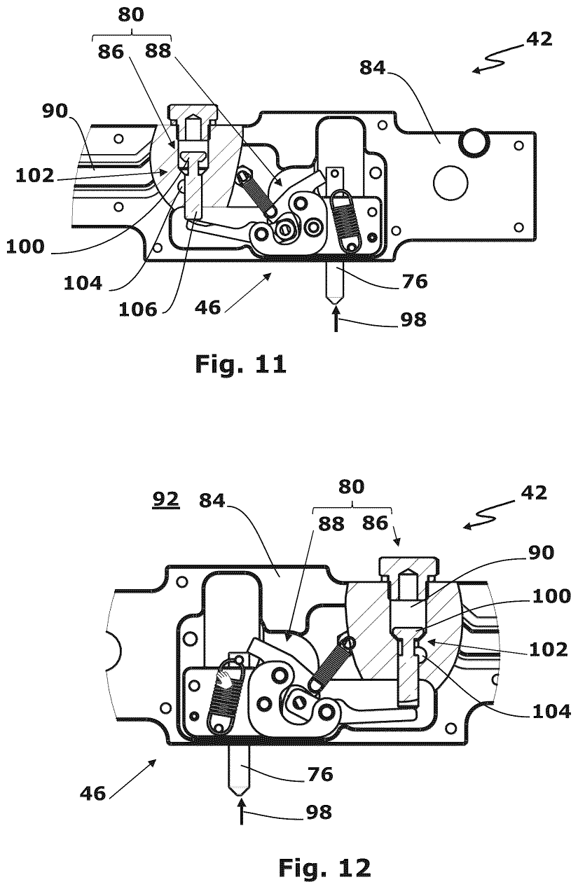

FIG. 11 shows a detailed view B of the measuring device 42 from FIG. 10.

If the measuring pin 76 is further deflected in the arrow direction 98, the valve head 100 of the pneumatic valve 86 is increasingly lifted out of the valve seat 102 of the base body 84 by the probe gear 88. As shown, a valve shaft 106 of the pneumatic valve 86 closes the flow path 104, so that the overpressure in the internal volume 90 can be restored for renewed triggering of a measuring probe 46.

The state of the pneumatic valve 86 is shown schematically in FIG. 15 for clarification.

FIG. 12 shows a detailed view C of the measuring device 42 from FIG. 10.

While the pneumatic valve 86 is closed according to FIG. 11, as the measuring pin 76 is deflected in the arrow direction 98, the pneumatic valve 86 is opened according to FIG. 12 by the probe gear 88 in a manner analogous to FIG. 9. The pressure drop in the internal volume 90 causes the measuring probe 46 to be detected.

The state of the pneumatic valve 86 is shown schematically in FIG. 14 for clarification.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 adjustment method;
12 additive manufacturing device;
14 process chamber;
16 process chamber base;
18 manufacturing plane;
20 manufacturing cylinder;
22 process plate
24 building platform;
26 coating element;
28 linear guiding;
30 carriage;
32 first main extension direction;
34 first guide rail;
36 second guide rail;
38 second main extension direction
39 coating tool;
40 coating lip;
42 measuring device;
44 method step;
46 measuring probe;
48 alignment position;
48 a first alignment position;
48b second alignment position;
50 reference position;
52 reference distance;
54 method step;
56, 58 height adjustment;
60 process plate position;
62 process plate distance;
64 method step;
66 reference segment;
70 reference segment height;
72 method step;
74 coating element location;
76 measuring pin;
78 method step;
80 probing mechanism;
82 measuring pin location;
84 base body;
86 pneumatic valve;
88 probe gear;
90 internal volume;
92 environment;
94, 96 measuring pin deflection;
98 arrow direction;
100 valve head;
102 valve seat;
104 flow path;
106 valve shaft;
A detail;
B detail;
C detail.

1. An adjustment method for aligning components of an additive manufacturing device using a coating element of the additive manufacturing device, the coating element having a measuring device, the method comprising:
d) positioning at least one measuring probe of the measuring device in an alignment position vertically above a process plate of the additive manufacturing device, wherein the measuring probe has a reference position with a vertical reference distance to a manufacturing plane of the additive manufacturing device; and
f) aligning the manufacturing plane and the process plate relative to each other by adjusting at least one height adjustment of the additive manufacturing device, wherein the adjusting is performed until the process plate contacts the measuring probe in the reference position.

2. The adjustment method according to claim 1, further comprising:
a) determining a reference segment of the additive manufacturing device, wherein the reference segment is formed parallel to a first main extension direction of the manufacturing plane of the additive manufacturing device;
b) aligning the coating element with the reference segment by lowering the coating element onto the reference segment.

3. The adjustment method according to claim 2, further comprising:
c) determining the vertical reference distance of the measuring probe to the manufacturing plane by probing the reference segment at least once with the measuring probe.

4. The adjustment method according to claim 1, further comprising:
e) deflecting a measuring pin of the at least one measuring probe in the vertical direction up to the process plate, wherein a process plate distance of the process plate to the manufacturing plane is determined,
wherein in method step f), the at least one height adjustment is adjusted by the process plate distance.

5. The adjustment method according to claim 1, wherein the steps d) to f) are performed for at least one further alignment position vertically above the process plate, wherein the at least one further alignment position is spatially spaced from the alignment position in the reference position.

6. The adjustment method according to claim 5, comprising at least one first alignment position and at least one second alignment position, wherein the first alignment position and the second alignment position are arranged parallel to a first main extension direction of the manufacturing plane.

7. The adjustment method according to claim 6, wherein the measuring device comprises at least two measuring probes, wherein adjustment of the at least one height adjustment is performed until the at least two measuring probes are probed in pairs in a respective alignment position of the alignment position, the first alignment position, and the second alignment position in the reference position by the process plate.

8. The adjustment method according to claim 6, wherein the steps d) to f) are performed for at least one further first alignment position and at least one further second alignment position, wherein the at least one further first alignment position and the at least one further second alignment position are arranged along a second main extension direction of the manufacturing plane at a distance from the at least one first alignment position and the at least one second alignment position.

9. A coating element for an additive manufacturing device configured to perform the adjustment method according to claim 1, comprising:
a coating lip; and
a measuring device with at least one measuring probe,
wherein the measuring probe protrudes in a vertical direction beyond the coating lip, and
wherein the measuring probe is configured for tactile probing through a process plate.

10. The coating element according to claim 9, wherein the measuring probe comprises a probing mechanism and a measuring pin, wherein the measuring pin is displaceable relative to the probing mechanism in order to detect probing by the process plate.

11. The coating element according to claim 10, wherein the measuring probe is configured to be arranged in a reference position by fixing a measuring pin location of the measuring pin relative to the probing mechanism.

12. The coating element according to claim 9, wherein the measuring probe is configured to be extendable in a vertical direction incrementally.

13. The coating element according to claim 9, wherein the probing mechanism has a pneumatic valve, and wherein the measuring pin is configured to switch the pneumatic valve.

14. The coating element according to claim 9, wherein the measuring device comprises at least two measuring probes, and wherein the at least two measuring probes are arranged perpendicular to a working axis of the coating element.

15. The coating element according to claim 9, wherein the measuring device is detachably arranged on the coating element.

16. An additive manufacturing device for additively manufacturing production orders in a process chamber of the additive manufacturing device, comprising a manufacturing cylinder having a process plate and the coating element according to claim 9, wherein the coating element is configured to move the measuring device along a second main extension direction of a manufacturing plane of the additive manufacturing device above the process plate.
